(19) United States
(12) Patent Application Publication
(10) Pub. No.: US 2025/0170918 A1
(43) Pub. Date: May 29, 2025

(54) CONTROL DEVICE

(71) Applicant: TOYOTA JIDOSHA KABUSHIKI KAISHA, Toyota-shi (JP)

(72) Inventor: Shingo YUMOTO, Nisshin-Shi (JP)

(73) Assignee: TOYOTA JIDOSHA KABUSHIKI KAISHA, Toyota-shi (JP)

(21) Appl. No.: 18/887,035

(22) Filed: Sep. 17, 2024

(30) Foreign Application Priority Data
Nov. 24, 2023 (JP) 2023-199375

(51) Int. Cl. B60L 53/62; B60L 53/10; H02J 4/00

(52) U.S. Cl. CPC B60L 53/62; B60L 53/11; H02J 4/00

(57) ABSTRACT

A control device includes a PWC circuit (first control circuit) that controls on/off of a DCR (switch) that connects the inlet and the battery pack (a battery) in the DC charging circuit, and an EV-ECU (a second control circuit) that controls on/off of DCR. Each of PWC circuit and EV-ECU operates to determine which of AC charge and DC charge is to be performed, and to turn off DCR if it is determined that AC charge is to be performed.

### CROSS-REFERENCE TO RELATED APPLICATION

This application claims priority to Japanese Patent Application No. 2023-199375 filed on Nov. 24, 2023, incorporated herein by reference in its entirety.

### BACKGROUND

### 1. Technical Field

The present disclosure relates to a control device.

### 2. Description of Related Art

Japanese Unexamined Patent Application Publication No. 2022-039337 (JP 2022-039337 A) discloses a vehicle including an alternating current (AC) port that receives AC power, a direct current (DC) port that receives DC power, and a battery. A charge relay is provided between each of the AC and DC ports and the battery.

### SUMMARY

Although not described in JP 2022-039337 A, a conventional charging system may be able to receive AC power and DC power through a common port (inlet). In order to suppress application of a DC voltage of a battery to an AC power source or the like, it is necessary to turn off a charge relay (switch) provided in a DC charging circuit during AC charge.

The present disclosure has been made in order to address the above issue, and an object of the present disclosure is to provide a control device capable of suppressing a switch that connects an inlet and a battery in a DC charging circuit being turned on during AC charge.

An aspect of the present disclosure provides
a control device that controls charging of an electric appliance with a common inlet for an alternating current charging circuit and a direct current charging circuit for charging a battery, including:
a first control circuit that controls on and off of a switch that connects the inlet and the battery in the direct current charging circuit; and
a second control circuit that controls on and off of the switch and that is different from the first control circuit.

Each of the first control circuit and the second control circuit determines which of alternating current charge and direct current charge is to be executed, and operates to turn off the switch when it is determined that the alternating current charge is to be executed.

In the control device according to the aspect of the present disclosure, as described above, each of the first control circuit and the second control circuit operates so as to turn off the switch when it is determined that AC charge is to be executed. Accordingly, even if one of the first control circuit and the second control circuit operates so as to turn on the switch during AC charge, it is possible to suppress the switch being turned on by operation of the other of the first control circuit and the second control circuit. As a result, it is possible to suppress the switch being turned on during AC charge as compared with when only one of the first control circuit and the second control circuit operates so as to turn off the switch during AC charge. Thus, it is possible to suppress a switch that connects the inlet and the battery in the direct current charging circuit being turned on during AC charge.

In the control device according to the one aspect, preferably, each of the first control circuit and the second control circuit determines which of the alternating current charge and the direct current charge is to be executed using first information based on an input voltage from an external power source that supplies charge power to the battery to the inlet and second information based on a signal from the external power source.

With this configuration, it is possible to make a determination using two pieces of information, that is, the first information based on the input voltage from the external power source and the second information based on the signal from the external power source. As a result, the reliability of the determination can be improved as compared with when the determination is made using only one of the two.

In this case, preferably,
the second information includes main information and sub information; and
the first control circuit
determines which of the alternating current charge and the direct current charge is to be executed using each of the main information and the sub information, and
determines which of the alternating current charge and the direct current charge is to be executed based on a result of a determination made using the first information, a result of a determination made using the main information, and a result of a determination made using the sub information.

With this configuration, the two determination results for the main information and the sub information can be used, and thus it is possible to further improve the reliability in determining which of alternating current charge and direct current charge is to be executed as compared with when only the main information is used.

The control device according to the one aspect preferably includes a first switch control circuit that outputs a control signal for controlling on and off of the switch to the switch, and that receives an operation command from each of the first control circuit and the second control circuit. The switch is turned off when the control signal includes an off command. The second control circuit outputs the operation command to the first switch control circuit such that the control signal includes the off command when it is determined that the alternating current charge is to be executed. With this configuration, the switch can be easily turned off by an operation command from the second control circuit.

In the control device according to the one aspect, preferably, the first control

circuit is configured to output a control signal for controlling on and off of the switch to the switch. The switch is turned off when the control signal includes an off command. The first control circuit
determines which of the alternating current charge and the direct current charge is to be executed using third information based on an input voltage from an external power source that supplies charge power to the battery to the inlet and fourth information based on a signal from the external power source, and
operates such that the control signal includes the off command when it is determined that the alternating current charge is to be executed.

With this configuration, it is possible to cause the first control circuit that outputs a control signal for controlling on and off of the switch to determine which of alternating current charge and direct current charge is to be executed. As a result, unlike when the above determination is made by a circuit different from a circuit that outputs a control signal for controlling on and off of a switch, there is no need to transmit the determination result to the circuit (a circuit that outputs a control signal). As a result, it is possible to suppress a delay in driving of the switch due to the time required to transmit the determination result (signal). Accordingly, it is possible to further suppress the switch being turned on during AC charge.

According to the present disclosure, it is possible to suppress a switch that connects an inlet and a battery in a DC charging circuit being turned on during AC charge.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an electrified vehicle according to a first embodiment;

FIG. 2 is a diagram illustrating a configuration of a charging circuit of electrified vehicle according to the first embodiment;

FIG. 3 is a diagram illustrating a configuration of a drive circuit of OBC according to the first embodiment;

FIG. 4 is a diagram illustrating a truth table of an AND circuit included in a drive circuit of an OBC according to the first embodiment;

FIG. 5 is a sequence diagram illustrating control in the control device according to the first embodiment;

FIG. 6 is a diagram illustrating a configuration of a charging circuit of an electrified vehicle according to a second embodiment; and

FIG. 7 is a sequence diagram illustrating control performed by the control device according to the second embodiment.

### DETAILED DESCRIPTION OF EMBODIMENTS

Hereinafter, an embodiment of the present disclosure will be described in detail with reference to the drawings. The same or corresponding parts in the drawings are designated by the same reference characters and repetitive description will be omitted.

### First Embodiment

### Charging System Configuration

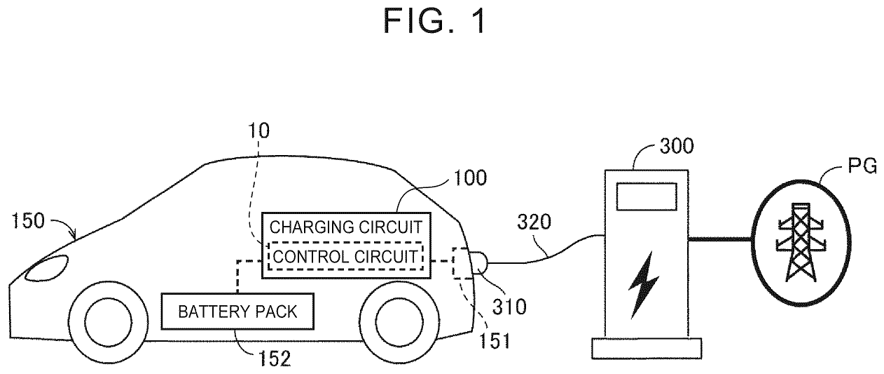

FIG. 1 is a diagram illustrating a charging device for charging an electrified vehicle 150 including a control device 10 according to a first embodiment. The power system includes an electrified vehicle 150, an electric vehicle supply equipment (EVSE) 300, and a power system PG. Note that electrified vehicle 150 and the power system PG are exemplary “electric devices” and “external power sources” of the present disclosure, respectively.

Electrified vehicle 150 includes charging circuit 100, inlet 151, and battery pack 152. The battery pack 152 is an example of a “battery” of the present disclosure.

Electric power for driving electrified vehicle 150 is stored in the battery pack 152. Charging power (AC power or DC power) from an external power source such as a power system PG is supplied to the battery pack 152. The charge power from the power system PG is supplied to the battery pack 152 through EVSE 300.

EVSE 300 is provided with a charging cable 320 provided with a charging connector 310. Electrified vehicle 150 is electrically connected to EVSE 300 through the charging cable 320 by connecting the charging connector 310 to the inlet 151. Consequently, the charging power from the power system PG is supplied to the battery pack 152 through EVSE 300 (charging cable 320).

Charging power from the power system PG inputted to the inlet 151 is supplied to the battery pack 152 through the charging circuit 100. The charging circuit 100 includes a control device 10. The control device 10 controls charging of the battery pack 152.

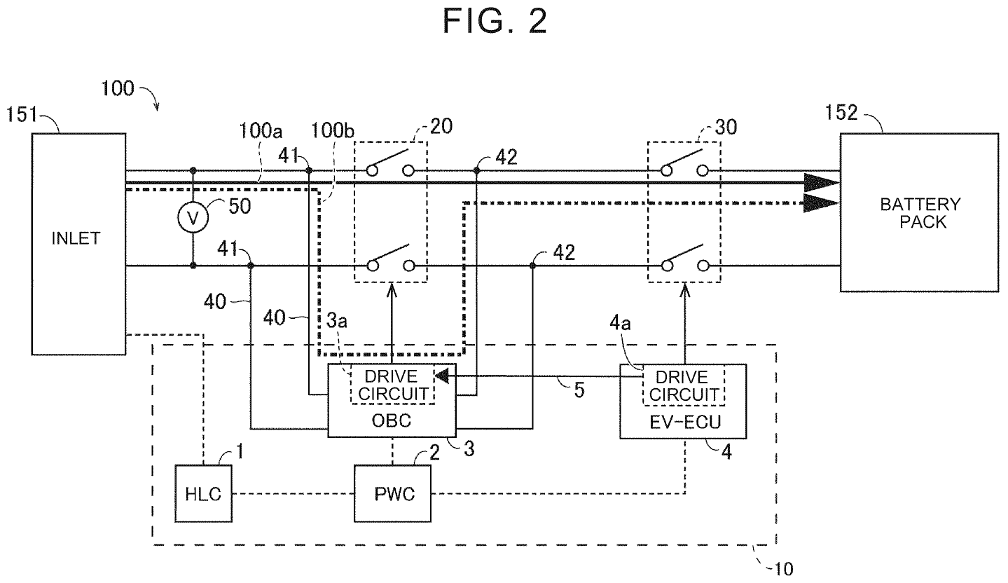

FIG. 2 is a diagram illustrating a configuration of the charging circuit 100. The charging circuit 100 includes a control device 10, a direct current relay (DCR) 20, a system main relay (SMR) 30, a by-pass path 40, and a voltage sensor 50. Note that DCR 20 is an exemplary “switching” of the present disclosure.

The control device 10 includes a high level communication (HLC) circuit 1, a pulse width controller (PWC) circuit 2, an on board charger (OBC) 3, and an electric vehicle electronic control unit (EV-ECU) 4. Note that PWC circuit 2 is an exemplary “first control circuit” of the present disclosure. In addition, OBC 3 and EV-ECU 4 are exemplary “first switch control circuit” and “second control circuits” of the present disclosure, respectively.

EV-ECU 4 is a circuit that differs from (is provided separately from) PWC circuit 2. Details of the control device 10 will be described later.

DCR 20 is provided in a DC charging circuit 100a (see a solid line arrow (bold line) in FIG. 2) for charging the battery pack 152. DCR 20 connects the inlet 151 and the battery pack 152 in DC charging circuit 100a. Specifically, DCR 20 is provided between the end portion 41 of the by-pass path 40 on the inlet 151 side and SMR 30. DC charging circuit 100a is a circuit in which current flows in the order of the inlet 151, DCR 20, SMR 30, and cell packs 152. DCR 20 is a relay that is controlled to be turned on when DC is charged and turned off when AC is charged.

SMR 30 is provided in each of an AC charging circuit 100b (see a broken line arrow (bold line) in FIG. 2) and a DC charging circuit 100a for charging the battery pack 152. SMR 30 connects the inlet 151 and the battery pack 152. Specifically, SMR 30 is provided between the end portion 42 of the by-pass path 40 on the battery pack 152 side and the battery pack 152. AC charging circuit 100b is a circuit in which current flows in the order of the inlet 151, OBC 3, SMR 30, and cell packs 152. SMR 30 is a relay that is turned on during each of DC charge and AC charge. The by-pass path 40 is included in AC charge-circuit 100b. The by-pass path 40 bypasses DCR 20.

As can be seen from the above explanation, in electrified vehicle 150, the inlet 151 is an inlet shared by AC charging circuit 100b and DC charging circuit 100a.

The voltage sensor 50 is provided between the inlet 151 and DCR 20. Specifically, the voltage sensor 50 detects a voltage between the inlet 151 and the end portion 41. The voltage sensor 50 detects an incoming voltage from the power system PG (EVSE 300) to the inlet 151. The data detected by the voltage sensor 50 is transmitted to OBC 3. OBC 3 transmits the acquired detected value of the voltage sensor 50 to each of PWC circuit 2 and EV-ECU 4 by communication. In the first embodiment, the information of the detection value by the voltage sensor 50 is an example of “first information” of the present disclosure.

HLC circuit 1 acquires information of the power system PG (hereinafter, referred to as system information) based on a signal from the power system PG inputted to the inlet 151. The power system PG may include, for example, an upper limit value, a lower limit value, a rated value, an AC frequency, and the like. HLC circuit 1 transmits the obtained system data to each of PWC circuit 2 and EV-ECU 4. In the first embodiment, the system information is an example of “second information” of the present disclosure.

PWC circuit 2 determines which of AC charge and DC charge is to be performed using the acquired system data. Here, the system information includes main information and monitoring information. The monitoring information includes information different from the main information. PWC circuit 2 uses each of the main information and the monitoring information to determine which of AC charge and DC charge is to be performed. The determination based on the monitoring information by PWC circuit 2 is transmitted to EV-ECU 4. Note that the monitoring information is an example of “sub information” of the present disclosure.

Each of PWC circuit 2 and EV-ECU 4 controls on/off of DCR 20. Each of PWC circuit 2 and EV-ECU 4 determines which of AC charge and DC charge is performed. EV-ECU 4 also controls on/off of SMR 30.

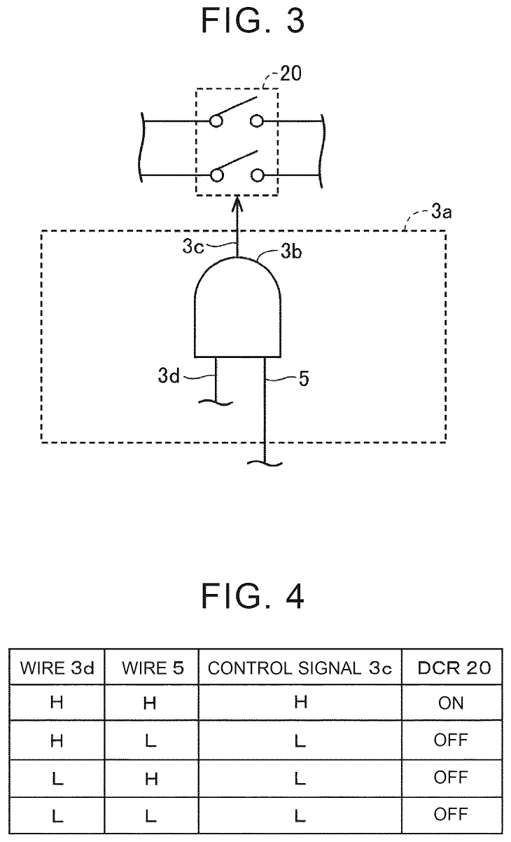

FIG. 3 is a diagram illustrating a configuration of a part of the drive circuit 3a included in OBC 3. The drive circuit 3a includes an AND circuit 3b. AND circuit 3b outputs a control signal 3c to DCR 20 for controlling on/off of DCR 20. A wire 3d inside the drive circuit 3a and a wire 5 extending from EV-ECU 4 are inputted to AND circuit 3b. Each of the wire 3d, the wire 5, and the control signal 3c transmits a digital signal having a logical value of “0” or “1”.

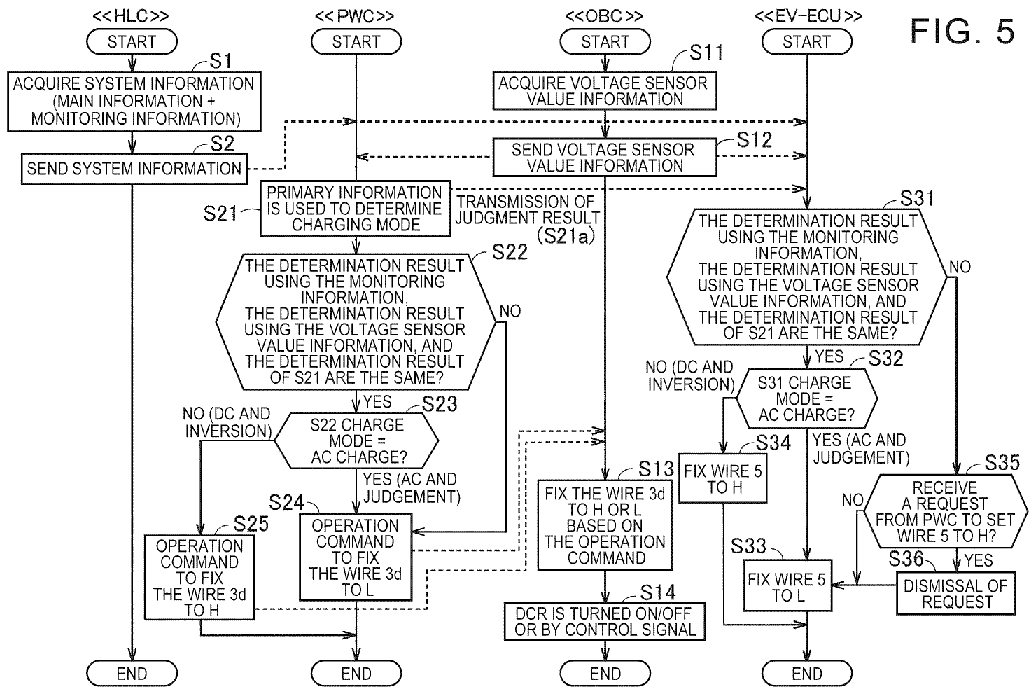

FIG. 4 is a diagram illustrating a relation between the wire 3d and the wire 5 and the control signal 3c and DCR 20. When the signal of each of the wire 3d and the wire 5 is an H signal (a signal of a logical value “1”), the control signal 3c becomes an H signal and DCR 20 is turned on. When at least one of the signal of the wire 3d and the signal of the wire 5 is an L signal (a signal of a logical value “0”), the control signal 3c becomes an L signal and DCR 20 is turned off. When the control signal 3c becomes the L signal, the “control signal includes an off-command” is exemplified.

Here, in order to suppress the DC-voltage of the batteries being applied to the external power source (the power system PG in the present embodiment), the charge relays provided in DC charging circuit need to be turned off during AC charge.

Therefore, in the present embodiment, each of PWC circuit 2 and EV-ECU 4 operates to turn off DCR 20 when it is determined that AC charge is executed. Thus, both PWC circuit 2 and EV-ECU 4 ensure that DCR 20 is turned off during AC charge. Hereinafter, the present disclosure will be described in detail with reference to FIG. 3.

PWC circuit 2 outputs an operation command to OBC 3. Specifically, when it is determined that AC charge is executed, PWC circuit 2 outputs an operation command for making the signal of the wire 3d the L signal to OBC 3. On the other hand, when it is determined that DC charge is executed, PWC circuit 2 outputs an operation command to change the signal of the wire 3d to the H signal to OBC 3.

EV-ECU 4 sets the signal of the wire 5 to the L signal when it is determined that AC charge is executed. EV-ECU 4 sets the signal of the wire 5 to the H signal when it is determined that DC charge is executed. Note that the wire 5 converted into the H signal or the L signal is an example of the “operation command from the second control circuit” of the present disclosure. Control Device Sequence

FIG. 5 is a sequential diagram illustrating control by HLC circuit 1, PWC circuit 2, OBC 3, and EV-ECU 4. The sequence illustrated in FIG. 5 may be executed at predetermined intervals (for example, every 10 minutes).

In S1, HLC circuit 1 acquires the above-described system information (main information+monitoring information). The system data is inputted to HLC circuit 1 through an inlet 151 (see FIG. 2).

In S2, HLC circuit 1 transmits the system information (main information+monitoring information) acquired in S1 to each of PWC circuit 2 and EV-ECU 4. The main data may not be transmitted to EV-ECU 4.

In S11, OBC 3 acquires information on the voltage value detected by the voltage sensor 50 (hereinafter, referred to as voltage value information).

In S12, OBC 3 transmits the voltage-value information obtained in S11 to each of PWC circuit 2 and EV-ECU 4.

In S21, PWC circuit 2 uses the system information (main information) received from HLC circuit 1 to determine which of AC charge and DC charge is executed (charge mode).

In S21a, PWC circuit 2 transmits the determination result in S21 to EV-ECU 4.

In S22, PWC circuit 2 determines whether or not the system information (monitoring information), the voltage-value information, and the system information (main information) are the same. When the charging mode determined based on the monitoring information in PWC circuit 2, the charging mode determined based on the voltage value information in PWC circuit 2, and the charging mode determined based on the main information in PWC circuit 2 (the determination result of S21) are the same (Yes in S22), the process proceeds to S23. When the three determination results (determined charge mode) are not the same (No in S22), the process proceeds to S24. Each of the monitoring information and the voltage value information is information for confirming (monitoring) that the main information is correct.

In S23, PWC circuit 2 determines whether or not the charging mode indicated in S22 (the charging mode determined based on the respective pieces of information described above) is AC charging. If AC charging is performed (S23 is Yes), it is determined that AC charging is performed, and the process proceeds to S24. If it is not AC charge (No in S23), it is determined that DC charge is performed, and the process proceeds to S25.

In S24, PWC circuit 2 transmits an operation command to OBC 3 so that the drive circuit 3a of OBC 3 has a wire 3d L. Thereafter, the process of PWC circuit 2 ends.

In S25, PWC circuit 2 transmits an operation command to OBC 3 so that the wire 3d becomes the H-signal. Thereafter, the process of PWC circuit 2 ends.

In S13, OBC 3 fixes the wire 3d to the H signal or the L signal based on an operation command of S24 or S25. Specifically, OBC 3 fixes the wire 3d to the L-signal when the operation command of S24 is received. OBC 3 fixes the wire 3d to the H-signal when S25 operation command is received. The process then proceeds to S14.

In S31, EV-ECU 4 determines which of AC charge and DC charge is executed by using the determination result using the system information (monitoring information), the determination result using the voltage value information, and the determination result in S21. When the charging mode determined based on the monitoring information in EV-ECU 4, the charging mode determined based on the voltage value information in EV-ECU 4, and the charging mode determined in S21 are the same (Yes in S31), the process proceeds to S32. When the three determination results (determined charge mode) are not the same (No in S31), the process proceeds to S35.

In S32, EV-ECU 4 determines whether or not the charge mode determined based on the respective pieces of information in S31 is AC charge. If AC charging is performed (S32 is Yes), it is determined that AC charging is performed, and the process proceeds to S33. If it is not AC charge (No in S32), it is determined that DC charge is performed, and the process proceeds to S34.

In S33, EV-ECU 4 fixes the wire 5 inputted to AND circuit 3b of OBC 3 to the L-signal. In S34, EV-ECU 4 fixes the wire 5 to the H-signal.

In S35, EV-ECU 4 determines whether or not it has received, from PWC circuit 2, a request to make the wire 5 H-signal. If the above-described requirement has been received (Yes in S35), the process proceeds to S36. If the above-described requirement has not been received (No in S35), the process proceeds to S33. Note that S35 process may not be executed.

In S36, EV-ECU 4 rejects the requisition received in S35. Thereafter, EV-ECU 4 process ends.

In S14, OBC 3 turns on/off DCR 20 by the control signal 3c based on the wire 3d and the wire 5.

As described above, in the first embodiment, each of PWC circuit 2 and EV-ECU 4 determines which of AC charge and DC charge is executed, and when it is determined that AC charge is executed, DCR 20 is turned off. Thus, even if the determination of one of PWC circuit 2 and EV-ECU 4 is abnormal, it is possible to suppress the DCR 20 from being turned on during AC charging based on the determination of the other of PWC circuit 2 and EV-ECU 4.

In the first embodiment, each of PWC circuit 2 and EV-ECU 4 uses the voltage-value information and the system information to determine which of AC charge and DC charge is executed. Thus, even if one of the voltage value information and the system information is abnormal, it is possible to suppress erroneous determination of which of AC charge and DC charge is executed based on the other of the voltage value information and the system information.

### Second Embodiment

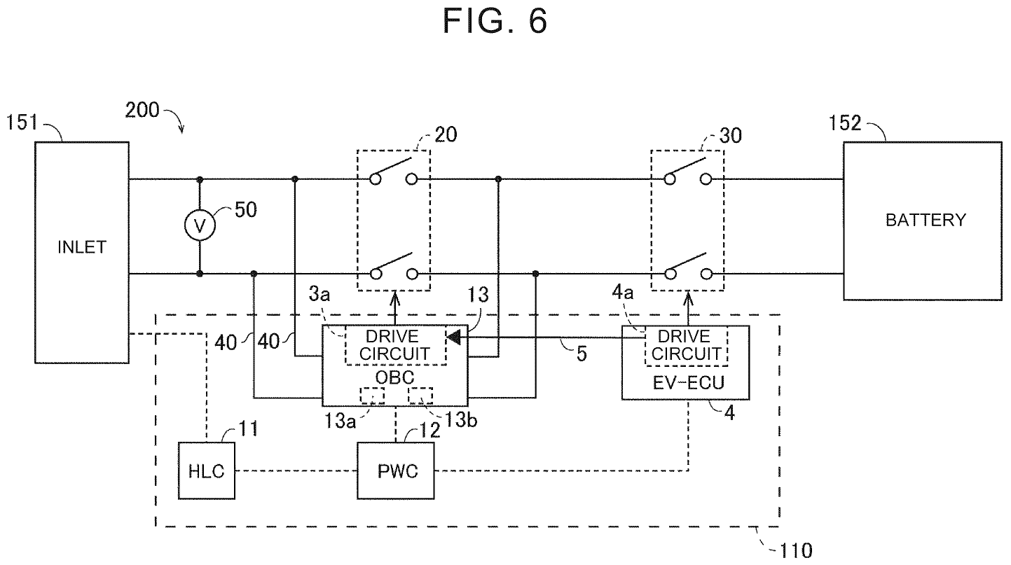

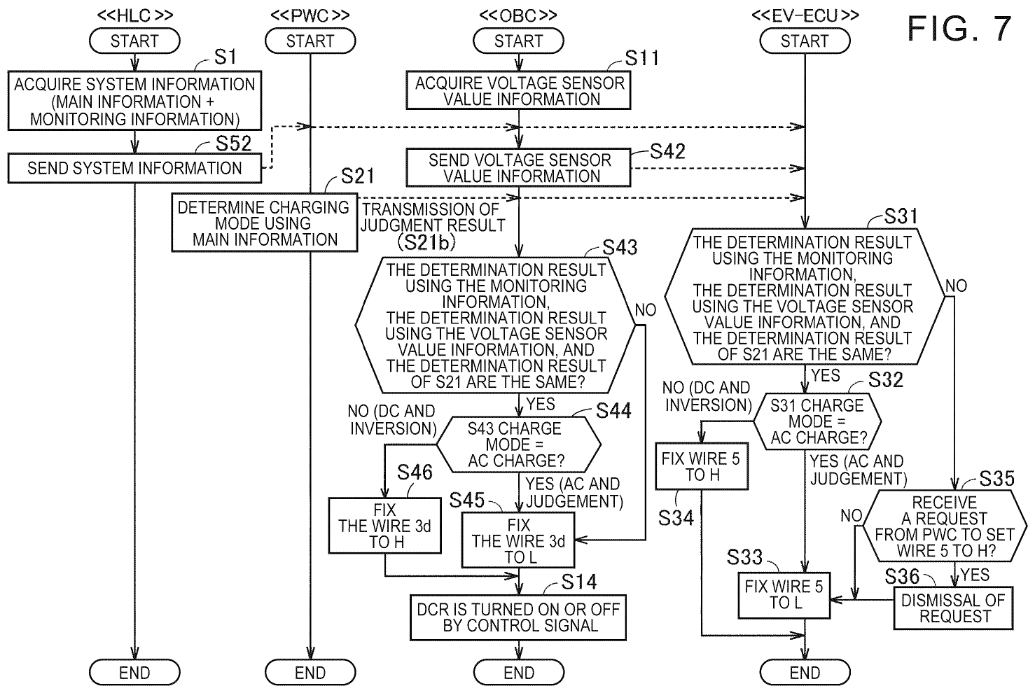

Next, the control device 110 according to the second embodiment will be described with reference to FIGS. 6 and 7. In the second embodiment, unlike the first embodiment, in which PWC circuit 2 determines which of AC charge and DC charge is to be performed, the determination is performed in OBC 13. The same components as those in the first embodiment are denoted by the same reference numerals and will not be described repeatedly.

### System Configuration

FIG. 6 is a diagram illustrating a charging circuit 200 including the control device 110 according to the second embodiment. The charging circuit 200 is different from the charging circuit 100 of the first embodiment in that a control device 110 is provided instead of the control device 10.

The control device 110 includes a HLC circuit 11, a PWC circuit 12, an OBC 13, and an EV-ECU 4. Note that OBC 13 is an exemplary “first control circuit” of the present disclosure.

OBC 13 includes a microcomputer (Micro Controller Unit) 13a and microcomputer 13b. The microcomputer 13a determines which of AC charge and DC charge is executed by using information (voltage value information) of the input voltage from the power system PG to the inlet 151. The microcomputer 13b determines which of AC charge and DC charge is executed by using the system information (main information). In the second embodiment, the voltage value information is an example of “third information” of the present disclosure. In the second embodiment, the system information (main information) is an example of “fourth information” of the present disclosure.

### Control Device Sequence

FIG. 7 is a sequential diagram illustrating control by HLC circuit 11, PWC circuit 12, OBC 13, and EV-ECU 4. The sequence illustrated in FIG. 7 may be executed at predetermined intervals (for example, every 10 minutes). Steps that are the same processes as those in the first embodiment are denoted by the same reference numerals and will not be described repeatedly.

In S52, HLC circuit 11 transmits the system information (main information+monitoring information) acquired in S1 to each of PWC circuit 12, OBC 13, and EV-ECU 4. The main data may not be transmitted to each of OBC 13 and EV-ECU 4. The monitoring data may not be transmitted to PWC circuit 12.

In S21b, PWC circuit 12 transmits S21 determination to each of OBC 13 and EV-ECU 4.

In S42, OBC 13 sends the voltage-value information obtained in S11 to EV-ECU 4.

In S43, OBC 13 determines which of AC charge and DC charge is executed by using the voltage value information and the system information (monitoring information) and the determination result of the charge mode by PWC circuit 12. Specifically, OBC 13 determines the charge-mode using the determination result by the microcomputer 13a (the determination result based on the voltage value information), the determination result by the microcomputer 13b (the determination result based on the monitoring information of the system information), and the determination result by PWC circuit 12. When the charging mode determined based on the voltage value information in OBC 13, the charging mode determined based on the monitoring information of the system information in OBC 13, and the charging mode indicated by the determination result of S21 are the same (Yes in S43), the process proceeds to S44. When the charge modes indicated by the three determination results are not the same (No in S43), the process proceeds to S45.

In S44, OBC 13 determines whether or not the charging mode indicated in S43 (the charging mode determined based on the respective pieces of information) is AC charging. If AC charging is performed (S44 is Yes), it is determined that AC charging is performed, and the process proceeds to S45. If it is not AC charge (No in S44), it is determined that DC charge is performed, and the process proceeds to S46.

In S45, OBC 13 controls the drive circuit 3a so that the wire 3d (see FIG. 3) of the drive circuit 3a of OBC 13 becomes the L-signal. The process then proceeds to S14.

In S46, OBC 13 controls the drive circuit 3a so that the wire 3d becomes the H-signal. The process then proceeds to S14.

Note that other configurations and controls are the same as those in the first embodiment, and therefore, repeated description will not be given.

In the above-described first and second embodiments, it has been shown that each of two circuits differing from each other determines which of AC charge and DC charge is performed, but the present disclosure is not limited thereto. Each of the three or more separate circuit may determine which of AC charge and DC charge is performed.

In the first and second embodiments, the voltage-value information and the system information are used to determine which of AC charge and DC charge is executed. The determination may be performed using information other than the above two pieces of information (for example, information such as a current value, temperature information, and a charging rate).

In the first and second embodiments described above, AND circuit 3b is provided in the drive circuit 3a of OBC 3 (13), but the present disclosure is not limited thereto. The configuration of the drive circuit 3a is not limited to the above-described embodiment. For example, OR circuit and the like may provide a control signal for controlling DCR 20.

In the first embodiment, PWC circuit 2 determines which of AC charge and DC charge is executed using the voltage value information, the system information (monitoring information), and the system information (main information), but the present disclosure is not limited thereto. PWC circuit may make the determination using one or two of the three pieces of information. Further, PWC circuit may perform the determination using four or more pieces of information obtained by further adding other information to the three pieces of information. Note that OBC 13 of the second embodiment and the determination in each of EV-ECU 4 of the first and second embodiments may be the same as those described above.

In the first and second embodiments, the charging circuit 100 (200) is electrically connected to the power system PG. The charging circuit 100 (200) may be electrically connected to a household appliance, for example. In this case, the household electric appliance is an example of an “external power source” of the present disclosure.

In the first and second embodiments, the control device 10 (110) is mounted on electrified vehicle 150, but the present disclosure is not limited to this. The control device may be mounted on an electric device other than electrified vehicle (for example, a stationary power storage device).

In the first and second embodiments, the voltage-value information is transmitted to EV-ECU 4 and PWC circuit 2 through OBC 3 (13), but the present disclosure is not limited thereto. For example, the voltage values may be transmitted from the voltage sensor 50 to each of EV-ECU 4 and PWC circuit 2.

Note that the control of the above-described embodiment and the above-described various modification examples may be performed in combination with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A control device that controls charging of an electric appliance with a common inlet for an alternating current charging circuit and a direct current charging circuit for charging a battery, the control device comprising:
a first control circuit that controls on and off of a switch that connects the inlet and the battery in the direct current charging circuit; and
a second control circuit that controls on and off of the switch and that is different from the first control circuit, wherein each of the first control circuit and the second control circuit
determines which of alternating current charge and direct current charge is to be executed, and
operates to turn off the switch when it is determined that the alternating current charge is to be executed.

2. The control device according to claim 1, wherein each of the first control circuit and the second control circuit determines which of the alternating current charge and the direct current charge is to be executed using first information based on an input voltage from an external power source that supplies charge power to the battery to the inlet and second information based on a signal from the external power source.

3. The control device according to claim 2, wherein:
the second information includes main information and sub information; and
the first control circuit
determines which of the alternating current charge and the direct current charge is to be executed using each of the main information and the sub information, and
determines which of the alternating current charge and the direct current charge is to be executed based on a result of a determination made using the first information, a result of a determination made using the main information, and a result of a determination made using the sub information.

4. The control device according to claim 1, further comprising a first switch control circuit that outputs a control signal for controlling on and off of the switch to the switch, and that receives an operation command from each of the first control circuit and the second control circuit, wherein:
the switch is turned off when the control signal includes an off command; and
the second control circuit outputs the operation command to the first switch control circuit such that the control signal includes the off command when it is determined that the alternating current charge is to be executed.

5. The control device according to claim 1, wherein:
the first control circuit is configured to output a control signal for controlling on and off of the switch to the switch;
the switch is turned off when the control signal includes an off command; and
the first control circuit
determines which of the alternating current charge and the direct current charge is to be executed using third information based on an input voltage from an external power source that supplies charge power to the battery to the inlet and fourth information based on a signal from the external power source, and
operates such that the control signal includes the off command when it is determined that the alternating current charge is to be executed.
